(19) United States
(12) Patent Application Publication
(10) Pub. No.: US 2010/0274610 A1
(43) Pub. Date: Oct. 28, 2010

(54) ORDER AGGREGATION SYSTEM AND METHOD

(75) Inventors: Mark V. Andersen, Lexington, MA (US); Christian H. Hescock, Cambridge, MA (US); Joseph I. Cohen, Cambridge, MA (US); Henri B. Weinberg, Lexington, MA (US); Christian M. Knott, Lowell, MA (US)

Correspondence Address: VISTA PRINT USA, INC.;ATTN: PATENT COUNSEL, 95 HAYDEN AVENUE, LEXINGTON, MA, 02421, US

(73) Assignee: VistaPrint Technologies Limited

(21) Appl. No.: 12/428,692

(22) Filed: Apr. 23, 2009

(51) Int. Cl. G06Q 10/00

(52) U.S. Cl. 705/8; 705/7

(57) ABSTRACT

A computerized system, method, and computer-readable medium implementing a method for aggregating orders for items to be filled is presented. Given a plurality of received orders, a plurality of individual orders that are aggregatable based on one or more predetermined aggregation criteria are identified and aggregated into an aggregate order. Items combined in the aggregate order may be grouped into one or more fulfillment groups independently of the individual orders from which the items originated and comprising items from the aggregate order to be simultaneously filled.

### BACKGROUND OF THE INVENTION

The present invention relates generally to order fulfillment operations, and more particularly to a system and method for aggregating fulfillment orders into efficient fulfillment groups.

Many consumer product retailers offer mail/phone/web-order service, either exclusively or in addition to a physical retail store. In a mail-order, phone-order, and/or web-order retail model, a retailer receives orders for products from customers via mail, phone, or the Internet. Payment arrangements are made, for example, by the customer sending in a check or money order, or charging a customer's credit card. The retailer fills the order, packages the items ordered, and ships the packaged items to the customer.

Online retailers, such as VistaPrint.com, typically offer a variety of products available for consumer purchase over the Internet via the World Wide Web. The online retailer has online presence in the form of a website executing on a server hosting the website, and may be accessed by a customer via a browser executing on a client computer connected to the Internet. The online retailer website may allow the customer to browse and/or design items for purchase and submit orders for such items via a graphical user interface executing in the browser of the client computer. Order and payment information is exchanged between the client computer and server(s) hosting the website, and the order is then sent to a fulfillment center to fill and ship the order.

It is not unusual for a customer to submit one or more additional orders prior to fulfillment by the retailer of a previously submitted order from the same customer. Often, such additional orders are to be shipped to the same address as the previously-submitted as-yet-unfilled order. For example, a customer may have forgotten to order an item that is needed for the previously ordered item, and then orders the item in a separate order. There are many reasons why a customer may submit multiple separate orders in a short time frame, but the result is typically the same—multiple separate orders to be shipped to the same address within a short range of time.

Typically, once an order reaches the fulfillment center of a mail/phone/web-order retailer, it is uncorrelated with any related orders. That is, an order comes in and it is filled and shipped, another order comes in and it is filled and shipped separately, yet another order comes in and it is filled and shipped separately, and so on.

### SUMMARY OF THE INVENTION

The present invention is directed at minimizing shipment costs by automatically aggregating orders where such aggregation will result in cost savings.

In an embodiment, a computerized method for aggregating orders includes identifying a plurality of orders that are aggregatable based on one or more predetermined aggregation criteria from a plurality of received orders for one or more items, aggregating the identified aggregatable orders into an aggregate order, and grouping the items indicated in the aggregate order into one or more fulfillment groups, each fulfillment group comprising a set of grouped items from the aggregate order to be simultaneously filled, wherein the items are aligned in the fulfillment groups independently of the received orders from which the items originated.

In another embodiment, one or more computer readable storage medium together tangibly embody program instructions which, when executed by a computer, implement the method above.

In yet another embodiment, an order aggregation system includes a pending orders database comprising a plurality of received order objects, each order object indicating one or more items to be shipped, and an order aggregator which searches the pending orders database and identifies a plurality of received order objects that are aggregatable based on one or more predetermined aggregation criteria, aggregates the identified aggregatable individual orders into an aggregate order, and groups the items indicated in the aggregate order into one or more fulfillment groups, each fulfillment group comprising a set of grouped items from the aggregate order to be simultaneously filled, wherein the items are aligned in the fulfillment groups independently of the individual orders from which the items originated.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a high-level flow diagram illustrating a mail/phone/web-order retail model.

FIG. 2 is a high-level block diagram of an online retail system embodying order aggregation in accordance with the invention.

FIG. 3 is an operational flowchart illustrating an exemplary embodiment of the method of the invention.

FIGS. 4A-4C diagrammatically illustrate order various embodiments of order aggregation.

FIG. 5 is a more detailed block diagram of a print management system of an online print retailer implementing order aggregation.

FIG. 6 is a block diagram of a computer system which may be used to implement computing features of the invention.

### DETAILED DESCRIPTION

As used herein, the term “fill” means to supply the items of an order or fulfillment group. An order may be “filled” in any number of ways, for example by retrieving stock items or manufacturing the items in the order.

As used herein, the term “fulfill” means to fill an order or fulfillment group and ship or deliver the filled order according to a specified shipment or delivery method. For example, an order may be fulfilled by shipping a package containing the filled order to a shipping address supplied by the customer. As another example, an order may be fulfilled by shipping one or more packages containing the filled order to a shipping address of a retailer where the customer will go to pick up the ordered items. As another example, an order may be fulfilled by delivering the items to a customer, for example at the location that the order is filled, or at a specified place of delivery.

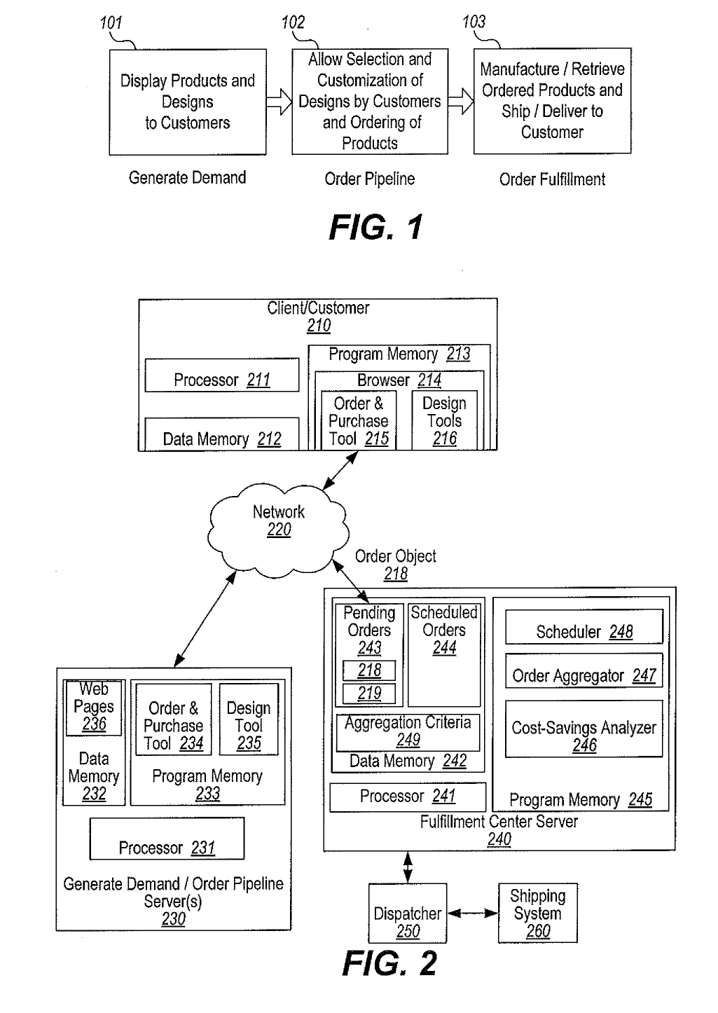

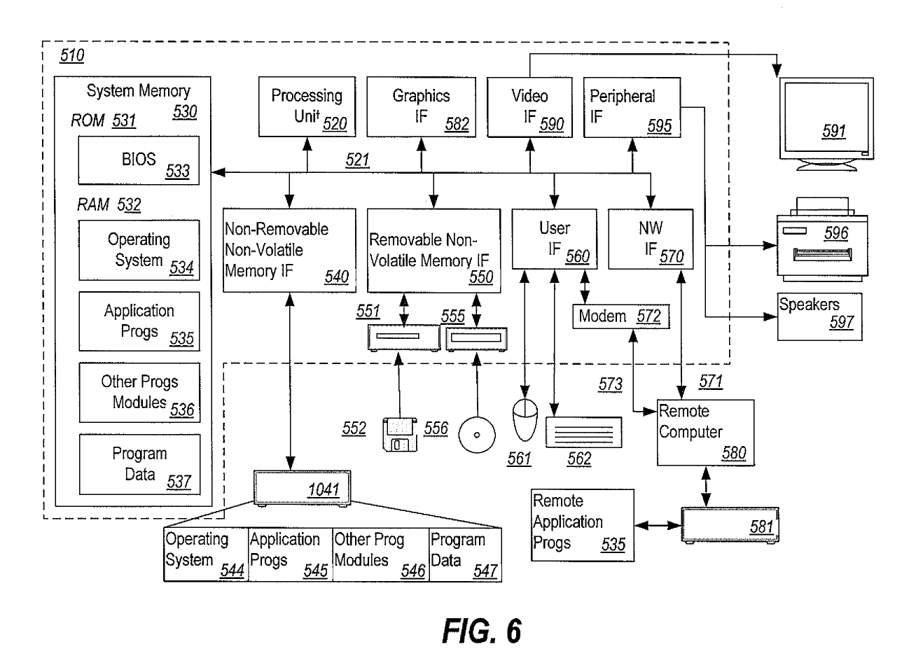

Turning now to the drawings, FIG. 1 shows a high-level flow diagram illustrating a mail/phone/web-order retail model. The model includes a Generate Demand component 101 through which customer interest in products offered by the retailer is generated. The Generate Demand component 101 may comprise, for example, web pages of an online retailer's website that display one or more products and various designs that may be embodied on the products that are available for ordering by a customer. The model further includes an Order Pipeline component 102 through which an order is actually specified and received. In an online retailer's website, the Order Pipeline component 102 may comprise studio software that allows the customer to select a product design template and customize text, image, and/or graphical components of the product design prior to ordering one or more products embodying the design. The model further includes an Order Fulfillment component 103 which accepts orders from the Order Pipeline component 102 and fills and ships the orders to the customers. In some instances, the Order Fulfillment component 103 includes a warehouse or other storage facility which stores stock products available and ready for shipment. In other instances, the Order Fulfillment component 3 is a manufacturing facility which manufactures the ordered items according to a design specified in the order. In an embodiment, each of the Generate Demand 101, Order Pipeline 102, and Order Fulfillment 103 components are implemented at least in part using one or more computer systems, for example as illustrated and discussed in connection with FIG. 6.

FIG. 2 is a high-level block diagram of an online retail system embodying order aggregation in accordance with the invention. As illustrated, a client computer system 210 being used by a customer or other user connects via a network 220 to the website of an online retailer hosted on a server 230. The server 230 serves web pages 236 to the browser 214 executing in program memory 213 under the control of the processor 211 of the client computer 210. The web pages 236 display items available for ordering by the customer browsing the website. Design tool(s) 216/235 may execute in the client computer browser 214 and/or at the website server 230 to allow the customer to select options and create customized designs for printing on, or otherwise manufacturing, an item being ordered. Order and Purchase tool(s) 215/234 execute in the client computer browser 214 and/or at the server 230 to allow the customer to complete an order and make payment arrangements. The Order and Purchase tool(s) 215/234 generate an order object 218, which preferably includes information such as a customer ID, a shipping address, item(s) ordered and associated quantities of ordered items. Other information may be included in the order object 218, such as, by way of example only and not limitation, customer information, method of shipment, a ship-by date, shipping speed, carrier selection, etc.

Order objects 218 generated by the Order and Purchase tool(s) 215/234 are transmitted, over a network 220 such as the Internet or via a direct connection, to a Fulfillment Center server 240. Preferably, the Fulfillment Center server 240 comprises one or more computers connected to the network, wherein order objects 218 are received over the network 220 for processing. Fulfillment Center server 240 enters orders represented by the order objects 218 into a database 243 of pending orders residing in data memory 242. The Fulfillment Center server 240 includes a scheduler 248 (e.g., scheduling software residing in program memory 245 executed by server processor 241) that scans the pending order database 243 and schedules orders to be fulfilled. Scheduled orders are removed from the pending orders database 243 and entered into a scheduled orders database 244. Alternatively, both pending and scheduled orders reside in a common database and are differentiated via one or more flag or field settings (e.g., a “pending” flag (such as a binary bit), a “scheduled” flag, a scheduled time field, etc.).

An order aggregator 247 (e.g., order aggregation software residing in program memory 245 and executed by server processor 241) scans pending orders in pending order database 243 and/or scheduled orders in scheduled order database 244, and combines pending orders and/or scheduled orders that meet predetermined aggregation criteria 249 into one or more aggregate orders. The aggregation criteria may be, by way of example and not limitation, a common customer identifier and a common ship-to address, similar ship-by dates, and common carrier. Aggregate orders may be placed in the pending orders database 243, or scheduled and placed in the Scheduled Order database 244.

A dispatcher 250 (for example a computerized system, a person, or machine) fills, by retrieving (e.g., from a warehouse) or manufacturing, items specified in a scheduled order or fulfillment group (to be discussed hereinafter) to generate a filled order or filled fulfillment group. A shipping system 260 (for example a computerized system, a person, or machine) packages the filled order or fulfillment group and sends or delivers the package(s) to the shipping address associated with the order/fulfillment group.

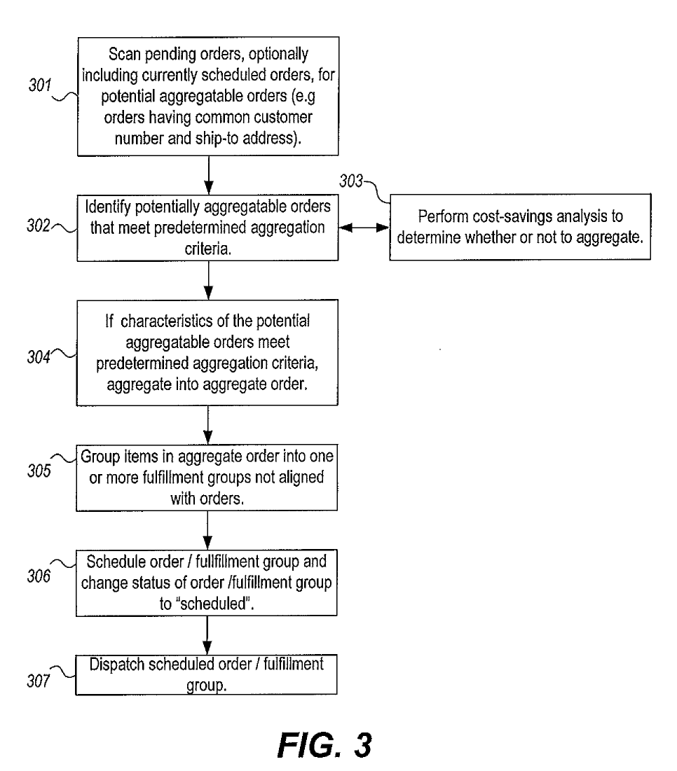

FIG. 3 is a flowchart illustrating an embodiment of a method for aggregating orders. The method described in FIG. 3 may be implemented by the order aggregator of FIG. 2, and in one embodiment is implemented as computer-readable instructions stored on at least one computer-readable medium and executed by a computer processor. Orders may be in one of at least two states: pending orders (orders received but not scheduled) and scheduled orders (orders scheduled for dispatch (i.e., fulfillment) but not yet dispatched). In an embodiment, the order aggregator scans the pending orders for sets of orders that may potentially be aggregated (step 301). A set of potentially aggregatable orders comprises orders that have common characteristics, such as, in one embodiment, identical customer numbers and identical ship-to addresses. Other common characteristics may include, by way of example only and not limitation, identical carrier selection, ship-by dates within a predetermined range of dates, identical retailer identifier, etc.

In another embodiment, the order aggregator scans not only the pending orders for sets of orders that may potentially be aggregated, but also scheduled orders that have not yet been dispatched.

In an embodiment, the order aggregator 247 performs the scan periodically according to a schedule. For example, the order aggregator may scan the pending orders (and optionally the scheduled orders) every few minutes, or every hour, or every several hours, or any other desired frequency. In an alternative embodiment, the order aggregator performs the scan specific to an incoming order each time an order is received and entered into the pending orders database. That is, the order aggregator software is called upon receipt of a new order object, or prior to entry of the new order object into the pending orders database, and performs a scan of the pending orders (and optionally the scheduled orders) for any orders having the same customer identifier (or retailer identifier) and ship-to address as the new order.

Upon identification of a set of potentially aggregatable orders, the method proceeds in the determination of whether the identified potentially aggregatable orders meet one or more predetermined aggregation criteria (step 302). The predetermined aggregation criteria are utilized by the order aggregator in determining whether or not to actually choose to aggregate the potentially aggregatable orders into an aggregate order. In an embodiment, the order aggregator performs a cost-savings analysis of fulfilling the individual orders separately, together, or in multiple shipments not aligned with the individual orders (step 303). The cost-savings analysis may take into account the requested shipping speeds of the individual orders, the weights and/or sizes of the items included in the individual orders, and other factors.

In one embodiment, the predetermined aggregation criteria is simply that each of the potentially aggregatable orders in the set must have the same customer identifier (or retailer identifier) and be shipping to an identical address. In this embodiment, the predetermined aggregation criteria is met simultaneously with the forming of the set of potentially aggregatable orders. In another embodiment, additional criteria must be met. For example, the predetermined aggregation criteria may require that each of the potentially aggregatable orders in the set must have a ship-by date within a predetermined time range (e.g., the ship-by date must all fall within a 2-day, a week, or a 14-day time frame). As another example, the predetermined aggregation criteria may require that each of the potentially aggregatable orders in the set must be set to ship by identical carrier (e.g., U.S. mail, UPS, FedEx, etc.). As another example, the predetermined aggregation criteria may require that each of the potentially aggregatable orders in the set must ship by identical shipping speed (e.g., ground, 2-day, next-day, etc.). Such example criteria may be combined and other criteria may be defined.

Furthermore, real-time cost-savings analysis may be performed, for example by Cost-Savings Analyzer 246 (See FIG. 2), by determining shipping costs under several different scenarios and selecting the least-cost scenario while still meeting the requested time frames of the individual orders. For example, given two individual orders with requested shipping speeds of 5-day and 10-day, the cost-savings analysis may determine that combining both orders into a single package and sending it via 5-day shipping speed is more cost-effective than sending the first order in one package via 5-day shipping speed and sending the second order on a separate package via 10-day shipping speed. In this case, the order aggregator may be configured to choose to aggregate the orders. On the other hand, if the cost-savings analysis determined that there would be no cost savings in aggregating the individual orders into a single order, the order aggregator may be configured to choose not to aggregate the individual orders into an aggregate order. The Cost-Savings analyzer 246 may take other factors into account in the cost-savings calculations, such as, by way of example only and not limitation, the costs of the packaging, the costs of storing the items while waiting for other items in the aggregate order to be ready, etc.

Upon determination that one or more potentially aggregatable orders meet the predetermined aggregation criteria, the method proceeds in the aggregation of the one or more potentially aggregatable orders into an aggregate order 219 (step 304). The aggregate order could be fulfilled as a single order without any further evaluation. Alternatively, the aggregate order could be evaluated to group the items in an aggregate order into one or more fulfillment groups (step 305). The items in an aggregate order 219 may be fulfilled together (i.e., as one fulfillment group) or in multiple different groups (for example, corresponding to multiple different packages and/or shipments). Each fulfillment group comprises one or more items from the aggregate order 219, wherein the groups are not generally correlated with the original individual orders aggregated into the aggregate order.

For example, the same customer (which could also be multiple customers sharing the same customer identifier or multiple customers ordering but having delivery to a given retailer identified by a particular retailer identifier) may place two or more separate orders with the same shipping address, resulting in two or more separate order objects being sent to the Fulfillment Center, and the order aggregation software may aggregate the two or more separate orders represented by the two or more separate order objects into a single aggregate order 219 (either by linking the two separate order objects or by combining the two or more separate order objects into a single aggregate order object). The items in the single aggregate order 219 may then be scheduled for fulfillment (step 306). A dispatcher monitors the schedule and dispatches scheduled orders and/or fulfillment groups for fulfillment at their scheduled times (step 307) wherein a fulfillment group of an order is filled (items from the group are collected or manufactured), preferably packaged in a common package, and shipped or delivered (i.e., all items belonging to the same fulfillment group are fulfilled). The shipment system may ship or deliver all items together in a single shipment or delivery, or may package the ordered items into multiple packages that, while shipped separately, contain one or more items that do not necessarily correlate to the individual orders 218 that together form the aggregate order 219.

That is, one of the features of an aggregate order 219 is that the determination of the item contents of the packages to be shipped or delivered is independent of knowledge of the individual orders 218. The order aggregator 247 (See FIG. 2) need only know that all of the items from all the individual orders 218 that make up the aggregate order 219 need to be fulfilled, allowing the order aggregator 247 flexibility in determining how to best group the items in the order for efficient filling, packaging and shipping.

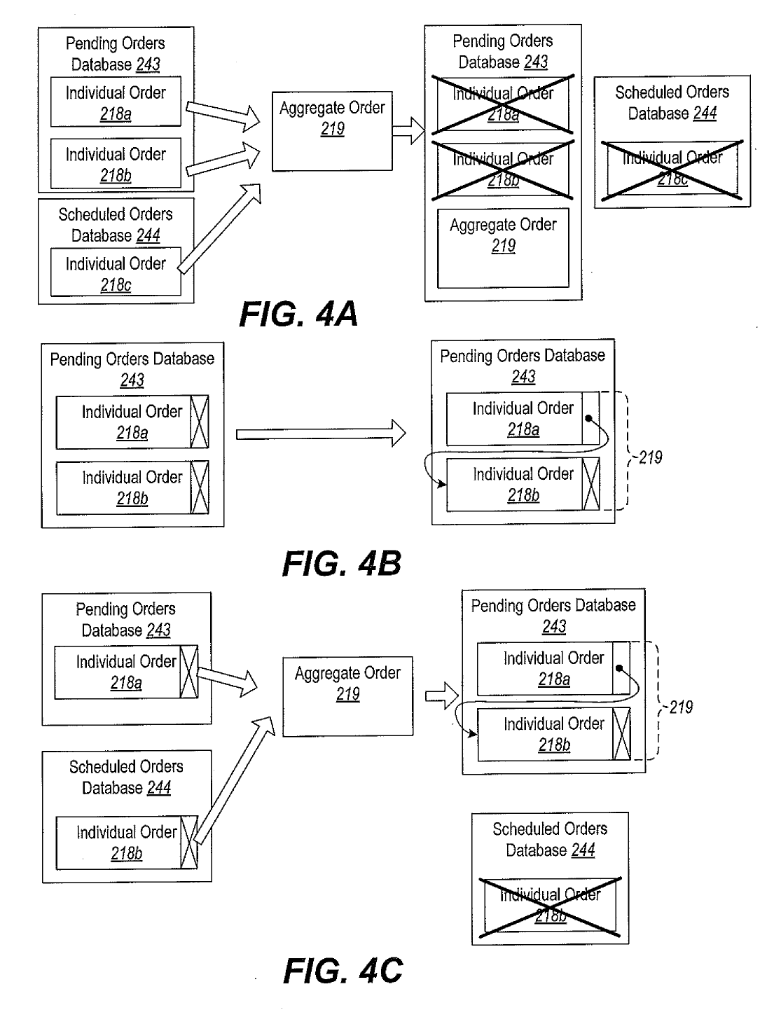

In an embodiment, as illustrated in FIG. 4A, individual orders 218a, 218b, 218c that are aggregated into an aggregate order 219 are combined into a single aggregate order 219 in the pending orders database 243, for example by first removing from the pending orders database 243 (and/or scheduled orders database 244) the order objects 218a, 218b, 218c selected for aggregation, then combining the selected order objects into a single aggregate order object 219, and then entering the single aggregated object 219 into the pending orders database 243. Alternatively, the aggregate order 219 could be immediately scheduled and entered into the scheduled order database 244).

In an alternative embodiment, illustrated in FIG. 4B, order objects 218a, 218b, 218c selected for aggregation are all pending orders and remain in the pending orders database 243, but are linked to each other via a link field to represent a single aggregate order 219.

In yet another alternative embodiment, illustrated in FIG. 4C, order objects 218 may reside in either the pending orders database 243 or the scheduled orders database 244, but any scheduled orders selected for aggregation are removed from the scheduled order database 244 (and hence are no longer scheduled) and moved to the pending orders database 243 and linked to other orders in the pending orders database 243 to together form the aggregate order 219.

The scheduler 248 order aggregator 247 may group items specified in an order (either an individual order 218 or an aggregate order 219) present in the pending orders database 243 into one or more fulfillment groups. A fulfillment group is a group of one or more items to be fulfilled at or around the same time as the other items (if more than one exist) in the same fulfillment group. In an embodiment, items belonging to the same fulfillment group are shipped or delivered together, preferably in as few packages as results in the greatest cost savings. In one embodiment, items are grouped into fulfillment groups such that the fulfillment groups align with the package that they will be shipped in. For example, one fulfillment group in a given aggregate order may comprise one item to be shipped in a first package at a first time, while another fulfillment group in the same aggregate order may comprise three items to shipped together in a second package at a second time.

The scheduler 248 schedules the fulfillment of orders 218 and/or 219 (either entire orders or according to corresponding fulfillment groups, independent of one another) without regard to which of the individual orders 218a, 218b, 218c that make up the aggregate order 219 that the particular items originated from.

Whenever an entire order or a fulfillment group is selected for scheduling and subsequently scheduled, the selected order or fulfillment group is entered into the scheduled orders database 244, and either removed from the pending orders database 243 or flagged as having been scheduled. When all fulfillment groups in an order are scheduled, the order removed from the pending orders database. An order or fulfillment group may be scheduled for fulfillment on the basis of a specific date/time, within a range of dates/times, or by a specific date/time. The scheduler 248 generates one or more schedules with assigned dates/times to fill and ship the orders/fulfillment groups.

The dispatcher 250 ensures that scheduled orders and scheduled fulfillment groups are filled at their assigned dates/times. Filled orders/fulfillment groups are packaged into one or more packages or shipping bundles, preferably as specified by the scheduler 248. The shipping system 260 ships or delivers the packaged orders/fulfillment groups. Filled scheduled orders or fulfillment groups are removed from the scheduled orders database 244.

Below is a set of example scenarios:
Customer places separate individual orders with the same shipping address within a short predetermined time frame (e.g., within an hour of one another). The order aggregator chooses to aggregate. The scheduler groups the aggregate order into
   (a) a single shipment (i.e., an entire order or one fulfillment group), or
   (b) into multiple shipments (i.e., multiple fulfillment groups), not aligned with the individual orders.
Customer places separate individual orders with the same shipping address over a longer predetermined time frame (e.g., within a few days of one another) with a same shipping speed (e.g., 21-day shipping speed). The order aggregator chooses to aggregate. The scheduler groups the aggregate order into
   (a) a single shipment (i.e., an entire order or one fulfillment group), or
   (b) into multiple shipments (i.e., multiple fulfillment groups), not aligned with the individual orders.
Customer places separate individual orders with the same shipping address over a longer predetermined time frame (e.g., within a few days of one another) with distinct shipping speeds (e.g., 7-day and 21-day shipping speeds). The order aggregator chooses to aggregate after calculating cost savings for adjusting carrier speeds. The scheduler groups the aggregate order into
   (a) a single shipment (i.e., an entire order or one fulfillment group), or
   (b) into multiple shipments (i.e., multiple fulfillment groups), not aligned with the individual orders.
Different retail customers at a retail store place separate individual orders to be delivered to the retail store shipping address over a predetermined time frame (e.g., within a few days of one another). The order aggregator chooses to aggregate. The scheduler groups the aggregate order into (a) a single shipment (i.e., an entire order or one fulfillment group) with individual customer orders packaged in inner boxes within one outer box, or (b) into multiple shipments (i.e., multiple fulfillment groups), not aligned with the individual orders and/or not aligned with the customers.

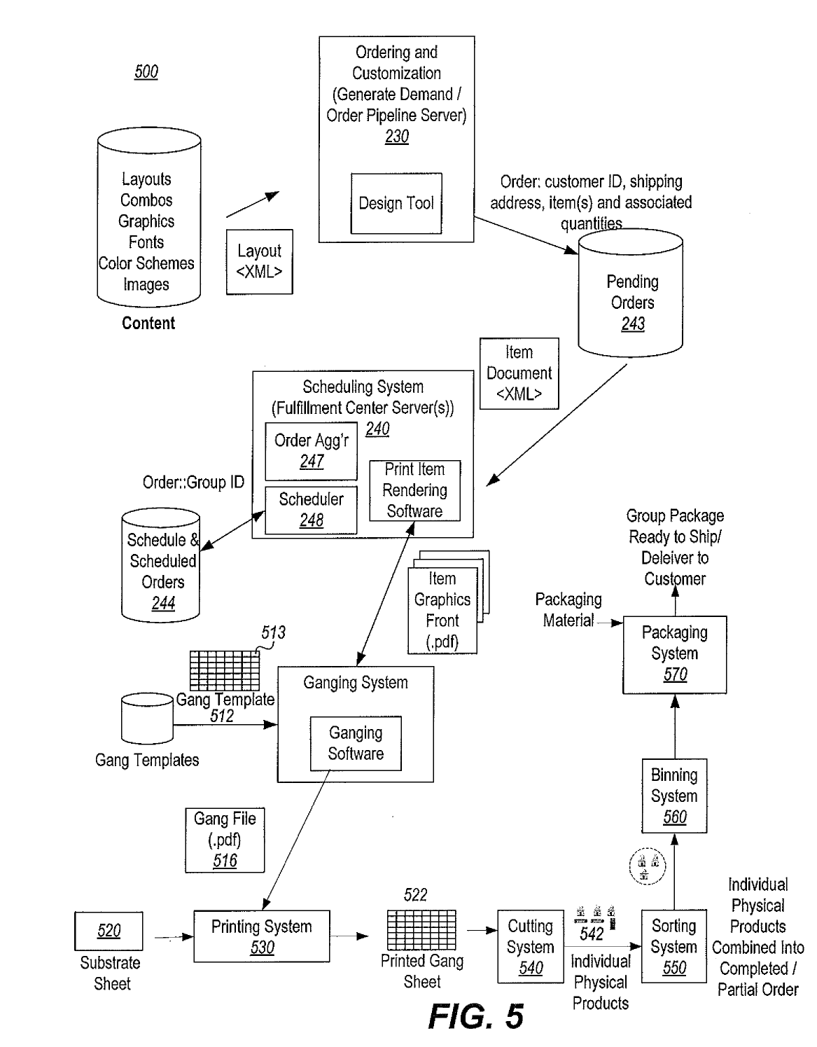

The fulfillment of customer orders may be aggregated not only in the context of collecting stock items and packaging them into efficient shipping bundles, but may also be aggregated in the context of efficient scheduling of items to be manufactured, for example, to implement a “just-in-time” system to eliminate the need for expensive storage and binning of items waiting for other items in the same order. For example, an implementation of an order aggregation system may be implemented in the context of a print job management system of an online printed products retailer, many of the details of which are described in U.S. Pat. No. 6,650,433, entitled “Managing Print Jobs” and in U.S. Pat. Pub. No. 2008/0080006 A1, entitled “Preparation of Aggregate Jobs for Production”, both of which are assigned to the Assignee of interest in the present application and which are hereby incorporated by reference in their entirety. In this context, and referring to FIGS. 2 and 5, a potentially enormous number (e.g., thousands or even hundreds of thousands or millions) of individual and commercial customers, wishing to place orders for one or more instances of a printed product or “print item” having a particular graphical design printed or otherwise affixed thereon, access the system over a network 220. In the illustrative embodiment, customers may access the system over the Internet via web browsers 214 (or similar interactive communication software) running on personal computers 210 or other electronic devices. Customers can access the system 500 (FIG. 5) through any one of several different types of entry ports into the print job management system, where some types of entry ports may be characterized by their economic and market characteristics. The types of entry ports could include home office/small office computer entry ports, intermediary ports (such as boutique stationery stores), and large corporate entry ports (such as a Communications Department of a large corporation). Other entry ports need not be based on web browsers, but could be, for example email links and dial up voice telephone lines. In other embodiments, the system may be a private system which provides customer kiosks or terminals allowing customers to access the system over a private network such as an Intranet.

In general, the orders 218 submitted by customers are short run manufacturing jobs, i.e., manufacturing jobs of a particular design and shape of less than 40,000 units, typically 1-5,000 units). Through the Internet, each customer can access a website that provides design software 216/235 that is made available from a central web server 230. The design software 216/235 allows each customer to customize a graphical design to be embodied on a printable product (e.g., business cards, brochures, mousepads, magnets, decals, sticky notes, etc.). The website design software 216/235 may execute directly on the web server 230, or may be downloaded from the server 230 as part of web pages 236 displayed to the user to run in the user's browser 214 (such as Microsoft Internet Explorer, Mozilla Firefox, etc.) on the customer's computer 210. In an embodiment, the design software 216/235 enables the customer to perform simple design functions by completing a selected template using a Design Wizard, or more complex design functions using a Design Studio, locally in the browser. In an embodiment, the templates are embodied using an XML format or other appropriate format. Alternatively, a customer or a professional designer could generate a template, using the website design software 216/235 itself, or using desktop publishing software, and upload it to the server 230.

Once the customer has completed customization of the design for the print item product, the customer places an order 218. The customer's print item design is sent to the Fulfill Demand server 240 in XML format, and the XML file is then converted by the Fulfill Demand server into a digital format, e.g., into a PostScript file (see FIG. 5).

The Fulfill Demand server(s) 240 execute order aggregation and scheduling software according to the method of FIG. 3 and as shown in greater detail in FIG. 5. As illustrated in FIG. 5, the order aggregator 247 monitors the pending orders 243 and may perform cost-savings analysis (via Cost-Savings Analyzer 246), to determine where and when to implement aggregation of orders that will result in cost savings. Order aggregation is discussed in connection with FIGS. 2 and 3. Only upon dispatch are orders or fulfillment groups processed by a ganging system 510 (FIG. 5) to fulfill demand in a “just-in-time” operation.

Ganging software 515 automatically aggregates, or “gangs together”, the customers file 514 (e.g., a PostScript file) with multiple files from other customers to produce a gang file 516 which will be printed as a single file on a single sheet of substrate, thereby simultaneously printing multiple print items. Because each of the items 514 aggregated into the gang file may come from different customers and contain different content, multiple customized print items may be manufactured together.

In an embodiment, and with reference to FIG. 5, individual print items 514 are arranged, by the ganging software 515, in a layout according to a predefined gang template 512. A gang template 512 is a file defining a plurality of pre-positioned empty slots 513. A slot 513 is a content container of pre-defined dimensions and positioned in the gang file layout in a unique pre-defined location in the gang template 512. Each empty slot 513 may be filled with a single print item 514 to be printed. The slots 513 in the gang template 512 are filled according to an automated ganging algorithm, executed within the ganging software 515. The ganging algorithm will preferably fill each slot 513 with a single print item 514 from a queue or database 243 of pending orders 218. The ganging algorithm is configured to fill a gang template 512 to capacity (by filling each slot 513 with an item 514 to be printed) or may only partially fill the gang template 512 for other reasons (such as meeting critical shipping deadlines when insufficient orders exist to fill the gang template). In either case, when the ganging algorithm determines that all print items 514 that will be ganged together have been added to the gang template 512, it saves the filled gang template into a gang document, which includes the gang template 512 and each of the print items 514 inserted in slots 513 therein, and converts the gang document into a single gang file 516 (such as a PostScript file).

The gang file 516 is sent to the printing system 530 (e.g., a prescriptions or printer) and printed onto a single sheet 520 of substrate. For example, the substrate 520 may be business card stock and the print item product may be business cards. In an example, a gang template 512 may be configured to allow 143 different business card items 514 that fit within identical size blank cells 513 measuring 3.5″×2″ and arranged in an 11 by 13 grid to be aggregated into a gang document and saved as a gang file 516, and printed on a single large sheet 520 of business card stock material measuring 1.0 meter by 0.6 meter. In other examples, different sizes of substrate material and item blank cells and the grid of blank cells can be arranged in different configuration.

The printed gang sheet 522 is sent to a cutting system 540 which cuts the printed gang sheet 522 into individual printed print items 542. The individual printed and cut items 542 are separated and sorted 550 into individual orders. Additional post-print processing, such as affixation of labels or binning an item while waiting for additional items belonging to the order or fulfillment group to be retrieved or manufactured, may be performed. The filled orders/fulfillment groups are then packaged and shipped/delivered to the respective customers, using shipping information that is displayed on a computer display in the shipping area of the printing facility.

Those of skill in the art will appreciate that the invented method and apparatus described and illustrated herein may be implemented in software, firmware or hardware, or any suitable combination thereof. Preferably, the method and apparatus are implemented in software, for purposes of low cost and flexibility. Thus, those of skill in the art will appreciate that the method and apparatus of the invention may be implemented by a computer or microprocessor process in which instructions are executed, the instructions being stored for execution on a computer-readable medium and being executed by any suitable instruction processor. Alternative embodiments are contemplated, however, and are within the spirit and scope of the invention.

FIG. 6 illustrates a computer system 610 that may be used to implement any of the servers and computer systems discussed herein. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 610. Computer storage media typically embodies computer readable instructions, data structures, program modules or other data.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 640 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6 provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 690.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

1. A computerized method for aggregating a plurality of orders comprising at least a plurality of individual orders, each individual order associated with at least a customer identifier, a shipping address, and one or more items, the method comprising the steps of:
identifying a set of aggregatable orders, the set of aggregatable orders comprising only orders associated with an identical customer identifier and an identical shipping address;
aggregating the identified aggregatable orders into an aggregate order associated with at least the identical customer identifier, the identical shipping address, and each of the set of items in each of the identified aggregatable orders; and
grouping the items indicated in the aggregate order into one or more fulfillment groups, the grouping performed independent of knowledge of the association of the items in the aggregate order to the individual orders, each fulfillment group to be filled independently from each other fulfillment group associated with the aggregate order;
wherein at least one of the identifying, aggregating and grouping steps are performed by at least one processor.

2. The method of claim 1, wherein prior to performing the aggregating and grouping steps:
performing, by at least one processor, a cost-savings analysis to determine whether fulfilling the identified set of aggregatable orders would be more cost-efficient by aggregating the identified aggregateable orders into an aggregate order and fulfilling the aggregate order, or by fulfilling the identified aggregateable orders as separate orders;
choosing, by at least one processor, to perform the aggregating and grouping steps if said cost analysis indicates that said aggregating is more cost-efficient; and
choosing, by at least one processor, to bypass the aggregating and grouping steps if said cost analysis indicates that said aggregating is not more cost-efficient.

3. The method of claim 2, wherein said cost analysis considers respective requested shipping speeds of the identified aggregatable orders.

4. The method of claim 2, wherein said cost analysis considers respective weights of the items to be filled in each of the identified aggregatable orders.

5. The method of claim 1, further comprising:
for each fulfillment group in an aggregate order, simultaneously filling all items belonging to the fulfillment group.

6. The method of claim 5, wherein the one or more fulfillment groups belonging to the aggregate order may be filled at different times.

7. The method of claim 5, wherein the step of filling comprises:
obtaining each of the items in the fulfillment group; and
shipping each of the obtained items at the same time.

8. The method of claim 7, further comprising:
packaging the obtained items into a common package prior to shipment.

9. The method of claim 5, wherein the step of filling comprises:
manufacturing each of the items in the fulfillment group; and
shipping each of the manufactured items at the same time.

10. The method of claim 9, wherein the items in the fulfillment group are manufactured simultaneously.

11. The method of claim 9, further comprising packaging the manufactured items into a common package prior to shipment.

12. The method of claim 1, further comprising:
scheduling each fulfillment group for fulfillment to generate a schedule; and
dispatching each fulfillment group for fulfillment according to the schedule.

13. The method of claim 12, wherein the identified aggregatable orders comprise only individual orders that have not yet been scheduled for fulfillment.

14. The method of claim 12, wherein the identified aggregatable orders comprise one or more individual orders that have not yet been scheduled for fulfillment and one or more aggregate orders that have not yet been scheduled for fulfillment.

15. The method of claim 12, wherein the identified aggregatable orders comprise any of: one or more individual orders that have not yet been scheduled for fulfillment, one or more individual orders that have been scheduled for fulfillment but have not yet been fulfilled, one or more aggregate orders that have not yet been scheduled for fulfillment, and one or more aggregate orders that have been scheduled for fulfillment but have not yet been fulfilled.

16. The method of claim 1, wherein all of the items identified in the aggregate order are grouped into a single fulfillment group to be filled together.

17. The method of claim 16, wherein all of the items identified in the aggregate order are packaged together in a single package for shipment.

18. The method of claim 1, wherein the items identified in the aggregate order are grouped into a plurality of fulfillment groups, each fulfillment group to be scheduled for fulfillment independently of the other fulfillment groups belonging to the aggregate order.

19. The method of claim 1, wherein the set of aggregatable orders further comprising only orders associated with an identical customer identifier, an identical shipping address, and a ship-by date within a predetermined range of dates.

20. The method of claim 19, wherein the set of aggregatable orders further comprising only orders associated with an identical shipping carrier.

21. One or more computer readable storage medium together tangibly embodying program instructions which, when executed by a computer, implement the method of claim 1.

22. An order aggregation system, comprising:
computer readable storage media storing a plurality of received order objects, each order object indicating one or more items to be shipped;
an order aggregator which searches the computer readable storage and identifies a plurality of received order objects that are aggregatable based on one or more predetermined aggregation criteria, aggregates the identified aggregatable individual orders into an aggregate order, and groups the items indicated in the aggregate order into one or more fulfillment groups, each fulfillment group comprising a set of grouped items from the aggregate order to be simultaneously filled, wherein the items are aligned in the fulfillment groups independently of the individual orders from which the items originated.

23. The order aggregation system of claim 22, further comprising:
a cost-savings analyzer which determines whether a cost savings would result aggregating the identified aggregatable individual orders into an aggregate order versus filling and grouping the identified aggregate individual orders in the aggregate order into one or more fulfillment groups and for each respective fulfillment group simultaneously filling individual orders belonging to the respective fulfillment group;
wherein the order aggregator aggregates the identified aggregatable individual orders if the cost-savings analysis determines that a cost savings would result by aggregating the identified aggregatable individual orders; and
wherein aggregation of the identified aggregatable individual orders is bypassed if the cost-savings analysis determines that a cost savings would not result by aggregating the identified aggregatable individual orders.
